(19) United States
(12) Patent Application Publication
(10) Pub. No.: US 2009/0216784 A1
(43) Pub. Date: Aug. 27, 2009

(54) System and Method of Storing Probabilistic Data

(76) Inventors: Steven J. Branda, Rochester, MN (US); William T. Newport, Rochester, MN (US); John J. Stecher, Rochester, MN (US); Robert Wisniewski, Rochester, MN (US)

Correspondence Address: CANTOR COLBURN LLP - IBM ROCHESTER DIVISION, 20 Church Street, 22nd Floor, Hartford, CT, 06103, US

(21) Appl. No.: 12/037,216

(22) Filed: Feb. 26, 2008

(51) Int. Cl. G06F 17/30

(52) U.S. Cl. 707/100; 707/E17.005

(57) ABSTRACT

A method of storing probabilistic data in accordance with an exemplary embodiment of the present invention includes capturing a first instance of a probabilistic data sample, storing the first instance of the probabilistic data sample as a probabilistic data record, collecting a second instance of the probabilistic data sample, refining the probabilistic data record with the second instance of the probabilistic data sample to establish a refined probabilistic data record, and saving the refined probabilistic data record in a probabilistic data record database.

### BACKGROUND OF THE INVENTION

1. Field of the Invention

This invention relates to the art of data storage systems and, more particularly, to a system and method of storing probabilistic data.

2. Description of Background

Currently, telecommunications providers are rapidly switching existing infrastructure over to Voice Over Internet Protocol or (VoIP) networks. VoIP provides more flexibility in managing networks, and allows infrastructure to be constructed from less expensive generic equipment. In addition, many corporations are switching existing internal voice networks over to VoIP for similar reasons. While deployment of VoIP systems is mainly driven by infrastructure costs, VoIP also provides some unique opportunities for new ways of managing voice communication. Voice streams that travel over a VoIP network can be easily decoded and processed by computers.

One advantage of decoding the voice streams is the ability to save biometric data, in the form of a voice fingerprint, associated with a particular individual. In most systems where biometric identification is used, the biometric data is associated with a user account. Thus, VoIP infrastructures in which each user has an individual account tied to a particular phone can make a fairly direct transition to using voice recognition. In such systems a person's voice fingerprint would be associated with their account. However, such a system becomes severely limited when a user calls from a phone, for example, in a conference room or a phone in another office, not associated with the user's account. Also, such a system would be of little benefit in broader networks such as, cell phone or home phone networks where several people commonly share a number of phones.

### SUMMARY OF THE INVENTION

The shortcomings of the prior art are overcome and additional advantages are provided through the provision of a method of storing probabilistic data in accordance with an exemplary embodiment of the present invention. The method includes capturing a first instance of a probabilistic data sample, storing the first instance of the probabilistic data sample as a probabilistic data record, collecting a second instance of the probabilistic data sample, refining the probabilistic data record with the second instance of the probabilistic data sample to establish a refined probabilistic data record, and saving the refined probabilistic data record in a probabilistic data record database.

System and computer program products corresponding to the above-summarized methods are also described and claimed herein.

Additional features and advantages are realized through the techniques of exemplary embodiments of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides for a robust system of sharing, refining and storing probabilistic data. By storing the probabilistic data in a central repository, and updating/refining the data with each acquisition of a new sample, data confidence is elevated. In addition, by storing the probabilistic data in a central repository that is accessible by all user accounts, biometric data, such as voice fingerprints, are no longer tied to a particular phone.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram illustrating a method of collecting and storing probabilistic data in accordance with an exemplary embodiment of the present invention; and

FIG. 2 illustrates one example of a system for capturing and storing probabilistic data in accordance with an exemplary embodiment of the present invention.

The detailed description explains the exemplary embodiments of the invention, together with advantages and features, by way of example with reference to the drawings.

### DETAILED DESCRIPTION OF THE INVENTION

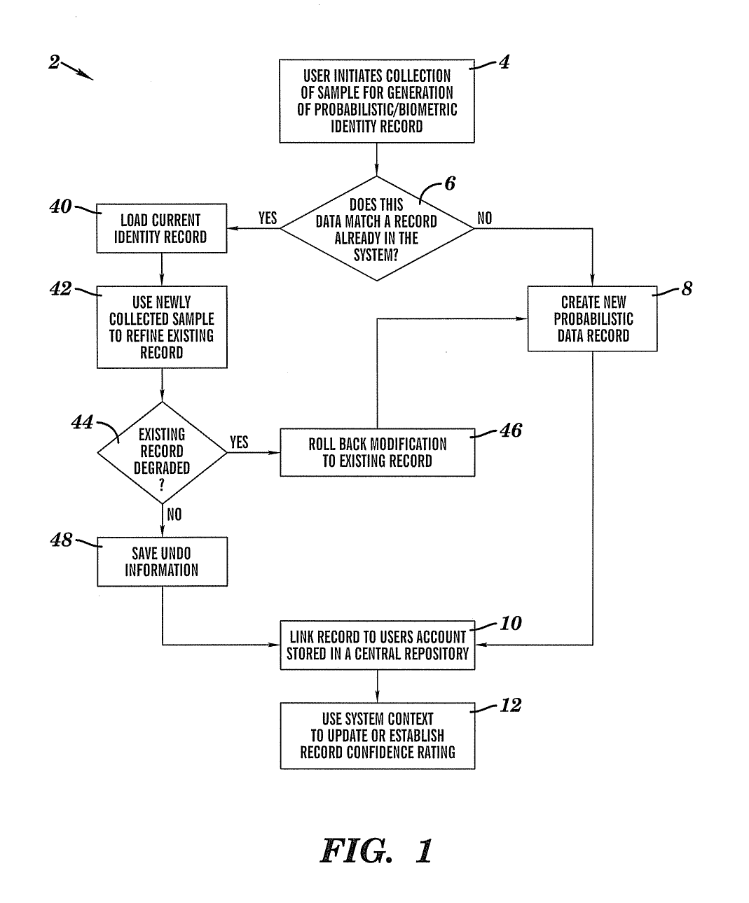

With initial reference to FIG. 1, there is illustrated a method 2 of capturing and storing probabilistic data in accordance with an exemplary embodiment of the present invention. Initially, a user initiates collection of a probabilistic data sample for use in generating a probabilistic data record as indicated in block 4. Collection of probabilistic data can include capturing a voice fingerprint, scanning a fingerprint either directly, or by scanning an image, scanning a human retina or other form of biometric identifier. Of course, it should be understood, that probabilistic data is not limited to only biometric data. Once the sample is collected, a determination is made whether a record exists that contains a matching sample in block 6. If no match is found, a new probabilistic data record is created in block 8. The new record is then linked to a user account and stored in a central repository in block 10. At this point, a record confidence rating is established.

If, however, a record having a matching sample does exist, that record is recalled and loaded into memory as indicated in block 40. Once loaded, the record is refined using the newly collected sample to create a refined probabilistic data record as indicated in block 42. That is, the existing record is scanned for any inconsistencies, holes, or other noise that would indicate poor data confidence. Using the newly collected sample, the existing record is manipulated to remove any noise that reflects poorly on record quality. At this point, the record is scanned to determine whether the manipulations resulted in a degradation of record quality in block 44. If the record is degraded, the manipulations are removed and the refined probabilistic data record is rolled back to pre-refined probabilistic data record as shown in block 46 and saved as a new probabilistic data record as indicated in block 8.

If, however, the refined probabilistic data record is of better quality than the pre-refined record, undo information is saved in block 48 and the refined probabilistic data record is re-associated or linked with the particular user account in block 10. At this point the record confidence rating is updated to reflect the improved record quality and the refined record is saved in the central repository in block 12. The undo information is also stored in the central repository and employed to roll back changes made in the refined probabilistic data record in the event problems arise that are not detected in block 44.

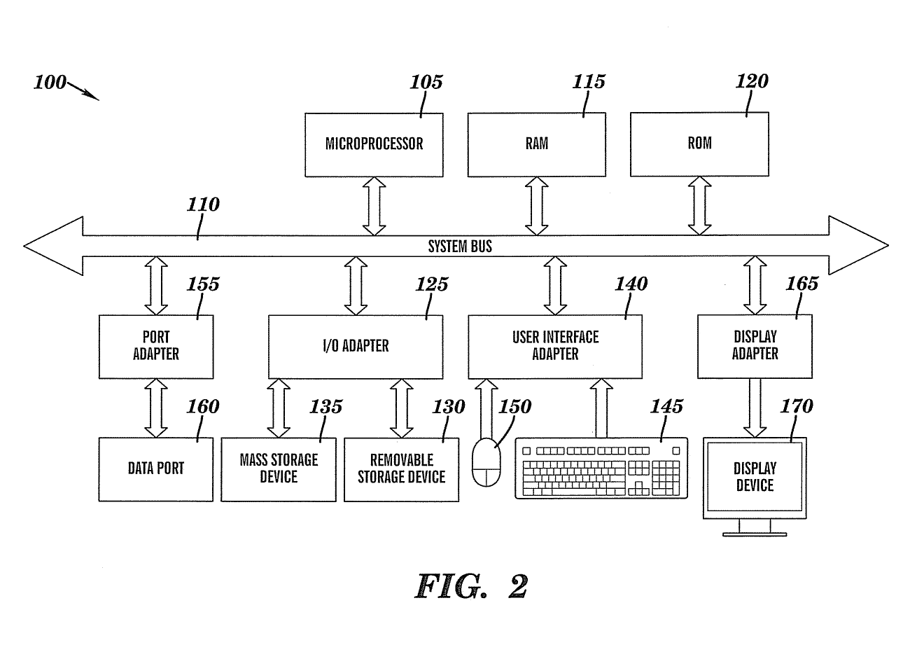

Generally, method 2 of capturing and storing probabilistic data described herein is practiced with a general-purpose computer, be that desktop computer, hand held computer, computer mainframe and/or combinations thereof. Method 2 may be coded as a set of instructions on removable or hard media for use by the above-described computer system. However, it should be understood that exemplary embodiments of the present invention can be run on a wide variety of computer platforms, a block diagram of one such system suitable for practicing the present invention embodiments is illustrated in FIG. 2. In FIG. 2, a computer system 100 has at least one microprocessor or central processing unit (CPU) 105. CPU 105 is interconnected via a system bus 110 to a random access memory (RAM) 115, a read-only memory (ROM) 120, an input/output (I/O) adapter 125 for a connecting a removable data and/or program storage device 130 and a mass data and/or program storage device 135, a user interface adapter 440 for connecting a keyboard 145 and a mouse 150, a port adapter 155 for connecting a data port 160 and a display adapter 165 for connecting a display device 170. Data port 160 can be configured to receive probabilistic data in the form of, for example, voice data through a telephone system (not shown), fingerprint data through a fingerprint scanner (not shown), retina data from a retina scanner or other forms of biometric data or probabilistic data samples.

ROM 120 contains the basic operating system for computer system 100. The operating system may alternatively reside in RAM 115 or elsewhere as is known in the art. Examples of removable data and/or program storage device 130 include magnetic media such as floppy drives and tape drives and optical media such as CD ROM drives. Examples of mass data and/or program storage device 135 include hard disk drives and non-volatile memory such as flash memory. In addition to keyboard 145 and mouse 150, other user input devices such as trackballs, writing tablets, pressure pads, microphones, light pens and position-sensing screen displays may be connected to user interface 140. Also, as noted above, input devices can include telephone systems for receiving voice data, fingerprint scanners, retina scanners and the like. Examples of display devices include cathode-ray tubes (CRT) and liquid crystal displays (LCD).

At this point it should be appreciated that the present invention provides a system and method for storing probabilistic data in way that provides central access while, simultaneously updating and refining existing probabilistic data record with each occurrence of a data sample collected. That is, the larger the number of samples collected for a particular record, the higher the confidence rating for that particular record. Also, by storing the probabilistic data record in a central repository, storing multiple samples of each data record is no longer required. In VoIP systems for example, a caller's identity can be verified even though calling from a “non-associated” phone. That is, the user's record is no longer linked to a particular phone but stored in a central repository. In this manner, voice verification can take place from any phone linked to the repository. In addition, each call made triggers a new data sample collection which is used to refine the user's record thereby raising confidence in the user's identity.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method of storing probabilistic data comprising:
capturing a first instance of a probabilistic data sample;
storing the first instance of the probabilistic data sample as a probabilistic data record;
collecting a second instance of the probabilistic data sample;
refining the probabilistic data record with the second instance of the probabilistic data sample to establish a refined probabilistic data record; and
saving the refined probabilistic data record in a probabilistic data record database.

2. The method of claim 1, further comprising: saving undo data associated with the refined probabilistic data record to allow the probabilistic data record to be restored from the refined probabilistic data record.

3. The method of claim 1, further comprising:
determining whether the refined probabilistic data record is degraded relative to the probabilistic data record; and
removing the second instance of the probabilistic data sample from the refined probabilistic data record to restore the probabilistic data record.

4. The method of claim 1, further comprising: linking the probabilistic data record to a user account.

5. The method of claim 4, further comprising: linking one of the probabilistic data record and the refined probabilistic data record to the user account.

6. The method of claim 5, further comprising: updating a confidence rating of the user account based on the refined probabilistic data record.

7. The method of claim 1, wherein capturing a first instance of the probabilistic data record includes capturing a fingerprint.

8. The method of claim 7, wherein capturing the fingerprint includes capturing a voice fingerprint associated with an identity of a particular user of a Voice Over Internet Protocol (VoIP) account.

9. A system for storing a probabilistic data record comprising:
a central processing unit (CPU), said CPU being interconnected functionally via a system bus to:
an input/output (I/O) adapter connecting to at least one of a removable data storage device, a program storage device, and a mass data storage device;
a user interface adapter connecting to a keyboard and a mouse;
a display adapter connecting to a display device; and
at least one memory device thereupon stored a set of instructions which, when executed by said CPU, causes said system to:
capture a first instance of a probabilistic data sample;
store the first instance of the probabilistic data sample as a probabilistic data record;
collect a second instance of the probabilistic data sample;
refine the probabilistic data record with the second instance of the probabilistic data sample to establish a refined probabilistic data record; and
save the refined probabilistic data record in a probabilistic data record database.

10. The system of claim 9, wherein the at least one memory device thereupon stored a set of instructions which, when executed by said CPU, causes said system to: save undo data associated with the refined probabilistic data record to allow the probabilistic data record to be restored from the refined probabilistic data record.

11. The system of claim 9, wherein the at least one memory device thereupon stored a set of instructions which, when executed by said CPU, causes said system to:
determine whether the refined probabilistic data record is degraded relative to the probabilistic data record; and
remove the second instance of the probabilistic data sample from the refined probabilistic data record to restore the probabilistic data record if the refined probabilistic data record is degraded.

12. The system of claim 9, wherein the at least one memory device thereupon stored a set of instructions which, when executed by said CPU, causes said system to: link the probabilistic data record to a user account.

13. The system of claim 12, wherein at least one memory device thereupon stored a set of instructions which, when executed by said CPU, causes said system to: link one of the probabilistic data record and the refined probabilistic data record to the user account.

14. The system of claim 13, wherein at least one memory device thereupon stored a set of instructions which, when executed by said CPU, causes said system to: update a confidence rating of the user account based on the refined probabilistic data record.

15. The system of claim 9, wherein the at least one memory device thereupon stored a set of instructions which, when executed by said CPU, causes said system to: capture a fingerprint as the first instance of the probabilistic data sample.

16. The system of claim 15, wherein at least one memory device thereupon stored a set of instructions which, when executed by said CPU, causes said system to: capture a voice fingerprint as the first instance of the probabilistic data sample and associate the voice fingerprint with an identity of a particular user of a Voice Over Internet Protocol (VoIP) account.

17. A computer program product comprising:
a computer useable medium including a computer readable program, wherein the computer readable program when executed on a computer causes the computer to:
capture a first instance of a probabilistic data sample;
store the first instance of the probabilistic data sample as a probabilistic data record;
collect a second instance of the probabilistic data sample;
refine the probabilistic data record with the second instance of the probabilistic data sample to establish a refined probabilistic data record; and
save the refined probabilistic data record in a probabilistic data record database.

18. The computer program product according to claim 17, wherein the computer readable program when executed on a computer causes the computer to: save undo data associated with the refined probabilistic data record to allow the probabilistic data record to be restored from the refined probabilistic data record.

19. The computer program product according to claim 17, wherein the computer readable program when executed on a computer causes the computer to:
determine whether the refined probabilistic data record is degraded relative to the probabilistic data record; and
remove the second instance of the probabilistic data sample from the refined probabilistic data record to restore the probabilistic data record if the refined probabilistic data record is degraded.

20. The computer program product according to claim 17, wherein the computer readable program when executed on a computer causes the computer to: link the probabilistic data record to a user account.

21. The computer program product according to claim 20, wherein the computer readable program when executed on a computer causes the computer to: link one of the probabilistic data record and the refined probabilistic data record to the user account.

22. The computer program product according to claim 17, wherein the computer readable program when executed on a computer causes the computer to: update a confidence rating of the user account based on the refined probabilistic data record.

23. The computer program product according to claim 17, wherein the computer readable program when executed on a computer causes the computer to capture a fingerprint as the first instance of the probabilistic data sample.

24. The computer program product according to claim 23, wherein the computer readable program when executed on a computer causes the computer to: capture a voice fingerprint as the first instance of the probabilistic data sample and associate the voice fingerprint with an identity of a particular user of a Voice Over Internet Protocol (VoIP) account.
